(19) United States
(12) Patent Application Publication
(10) Pub. No.: US 2023/0032595 A1
(43) Pub. Date: Feb. 2, 2023

(54) AUTOMATED REDISTRIBUTION LAYER POWER CONNECTIONS

(71) Applicants: Advanced Micro Devices, Inc., Santa Clara, CA (US); ATI Technologies ULC, Markham (CA)

(72) Inventors: Rajagopalan Venkatramani, Hsinchu (TW); Renato Dimatula Gaddi, Markham (CA); Dennis Glenn Lozanta Surell, Markham (CA); Liane Martinez, Markham (CA)

(21) Appl. No.: 17/564,725

(22) Filed: Dec. 29, 2021

Related U.S. Application Data
(60) Provisional application No. 63/228,550, filed on Aug. 2, 2021.

(51) Int. Cl. G06F 30/392

(52) U.S. Cl. CPC G06F 30/392

(57) ABSTRACT

A system and method for automatically generating layout masks of power rails within redistribution layers of a semiconductor package are described. In various implementations, a user defines attributes to use for automatic power rail generation in the redistribution layers. The circuitry of a processor of a computing device used by the user executes instructions of a redistribution layer (RDL) automated power rail generator, which is referred to as the power rail generator. The power rail generator uses the attributes and a copy of the RDL netlist of the signal routes within the RDL to generate RDL mask layout data representing the signal routes of the power rails within the RDL. The processor generates the power rails for a significantly large number of signal routes in the RDL based on the received data such as the attributes that allow the user to customize the automatic generation.

### CROSS REFERENCE TO RELATED APPLICATIONS

This application claims priority to Provisional Patent Application Ser. No. 63/228,550 entitled “SILICON LAYOUT FOR AN AUTO POWER RAIL” filed Aug. 2, 2021, the entirety of which is incorporated herein by reference.

### BACKGROUND

### Description of the Relevant Art

There is a growing demand for semiconductor packages that provide communication between one or more integrated circuits in a chip package and external components on a motherboard located externally from the chip package. Electronic products associated with mobile computing, wearable electronics, and the Internet of Things (IoT) drive the demand for small packages that utilize vertical signal interconnections. Examples of the chip packages used in these products include ball grid arrays (BGAs), chip scale packages (CSPs), and System in Packages (SiPs).

The semiconductor package utilizes controlled collapse chip connection (C4) interconnections, which is also referred to as flip-chip interconnection. For example, C4 bumps are connected to vertical through silicon vias (TSVs) formed in a silicon package substrate that has connections to the printed circuit board using bump pads. Groups of TSVs forming through silicon buses are used as interconnects between a base die, one or more additional integrated circuits, and routing on a printed circuit board (PCB) such as a motherboard or a card. The demand for SiPs and more signal interconnects between the integrated circuits and the printed circuit board (PCB) also increases the demand for package substrates and interposers.

The package substrate is a part of the chip package that provides mechanical base support as well as provides an electrical interface for the signal interconnects. An interposer is an intermediate layer between the one or more integrated circuits and either flip chip bumps or other interconnects and the package substrate. When used, the interposer provides the electrical interface for the signal interconnects between the die assembled on it (die-to-die interconnects) and the package substrate (die-to-package interconnects). Depending on the implementation, the terms package substrate and interposer are used interchangeably.

The one or more integrated circuits within the semiconductor package have signal routes connected between them and the motherboard (or printed circuit board) using redistribution layers. The signal routes of the redistribution layers are signal routes located between the micro-bumps that make contact with pads on the integrated circuit and through silicon vias (TSVs) of a silicon package substrate.

Although innovations provide improvements, design issues still arise with modern techniques in processing and integrated circuit design that limit potential benefits. One issue is the one or more integrated circuits have tens of thousands of nodes for receiving one or more power supply voltage reference levels and one or more ground reference voltage levels while there are hundreds of nodes for transferring these voltage reference levels at the TSVs. The routing of these power connections through the redistribution layers becomes complex. Manually routing the signals corresponding to these power connections through the redistribution layers before performing verification checks and later fabrication takes weeks or months.

In view of the above, efficient methods and systems for routing signals corresponding to power connections within the redistribution layers are desired.

### BRIEF DESCRIPTION OF THE DRAWINGS

FIG. 1 is a generalized diagram of a computing system.

FIG. 2 is a generalized diagram of a cross-sectional view of a semiconductor package metal layer scheme.

FIG. 3 is a generalized diagram of metal layers of redistribution layers.

FIG. 4 is a generalized diagram of metal layers of redistribution layers.

FIG. 5 is a generalized diagram of a graphical user interface.

FIG. 6 is a generalized diagram of a method for automatic routing of signals corresponding to power connections within redistribution layers.

FIG. 7 is a generalized diagram of a method for automatic routing of signals corresponding to power connections within redistribution layers.

FIG. 8 is a generalized diagram of signal routes confined by boundary regions.

FIG. 9 is a generalized diagram of a method for automatic routing of signals corresponding to power connections within redistribution layers.

FIG. 10 is a generalized diagram of a method for automatic routing of signals corresponding to power connections within redistribution layers.

FIG. 11 is a generalized diagram of a computing system.

While the invention is susceptible to various modifications and alternative forms, specific embodiments are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Systems and methods for automatically creating layout masks for signal routes of power connections within redistribution layers are contemplated. As used herein, the term “automatic generation” or “automatically generating” refers to having the ability to perform generation, or perform generating steps, without user intervention. As disclosed herein, a computing device used by the user includes hardware, such as circuitry of a processor, to execute instructions of an automated redistribution layer (RDL) power rail generator, which is referred to as the auto power rail generator. A user defines attributes for the auto power rail generator to use for automatically creating the layout masks of signal routes of the power connections within redistribution layers of a semiconductor package. The power connections provide one or more power supply voltage reference levels and one or more ground reference voltage levels between an integrated circuit and a motherboard. In one implementation, the user provides the attributes through a graphical user interface (GUI). In another implementation, the user provides the attributes through a text file or an executable file written in one of a variety of scripting languages.

The auto power rail generator uses the attributes and a copy of the RDL netlist of the signal routes within the RDL. When the processor of the computing device executes the instructions of the auto power rail generator, the processor selects a metal layer of the redistribution layers based on the attributes provided by the user. The processor selects one of the power rails based on a prioritized sequences specified by the attributes. The processor places the layout masks of the selected power rail within any defined boundary for the metal layer as specified by the attributes.

The processor uses a routing orientation and metal density specified by the attributes. The processor repeats these steps for each of the metal layers and power rails identified in the attributes. In some cases, the processor performs DRC checks and verifies intermetal overlap specifications for each combination of metal layer and power rail before moving on to another combination. Afterward, the processor generates a report. The processor maintains a log file during the automatic via generation and uses the corresponding information to provide summarized results in the report. In various implementations, the processor writes a file located in a known destination.

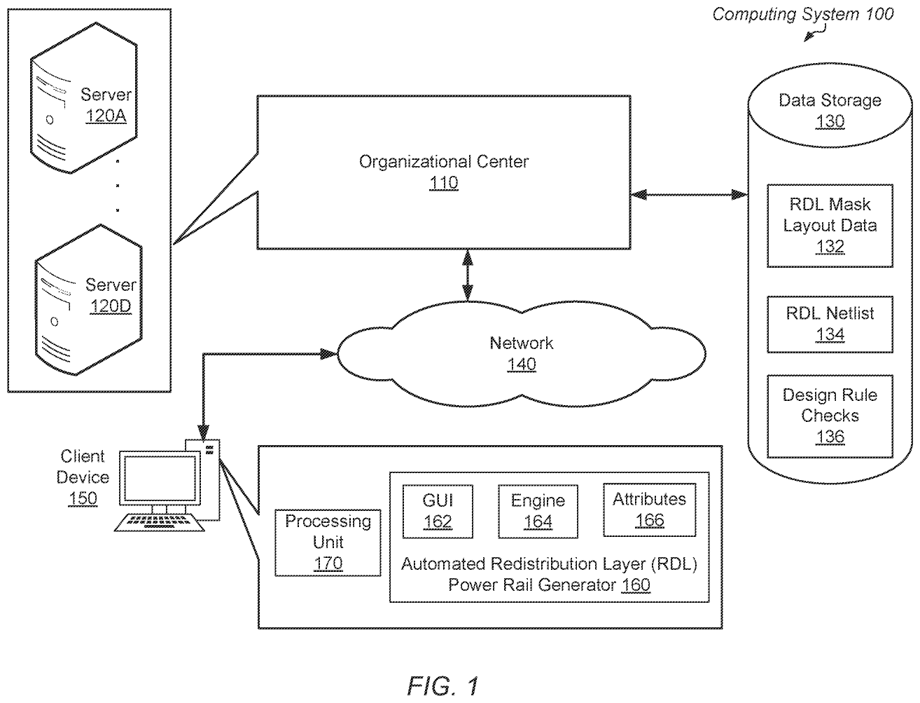

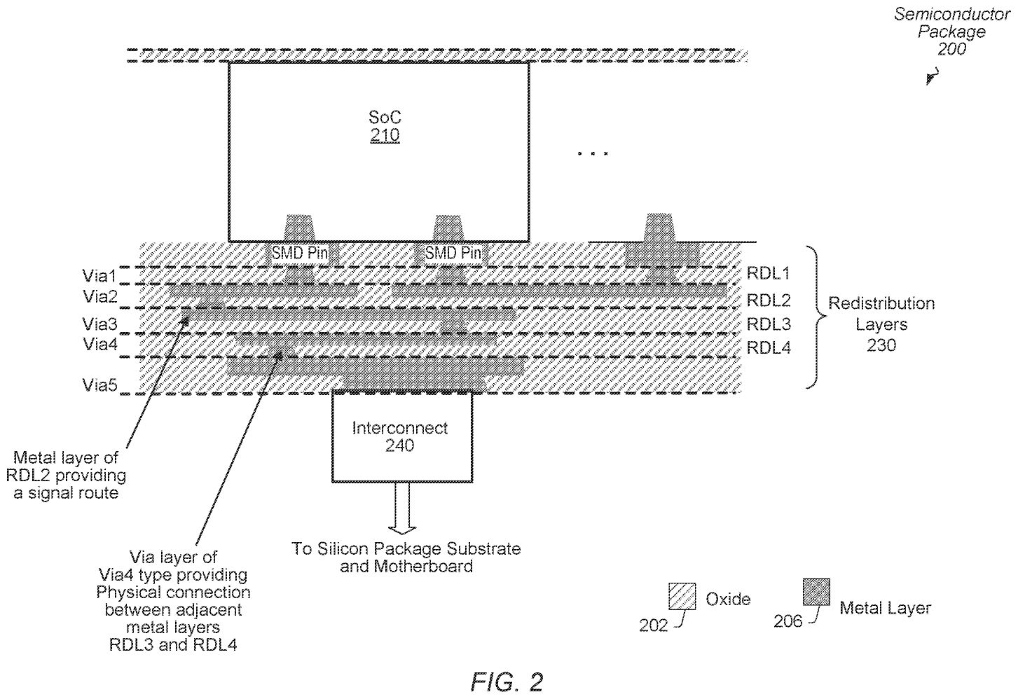

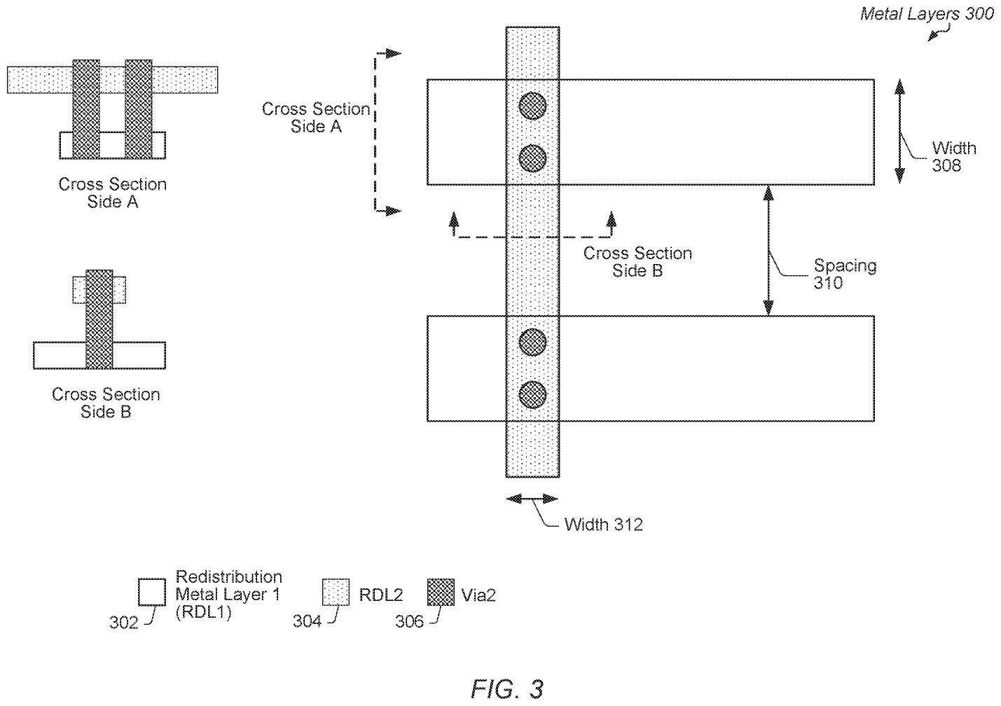

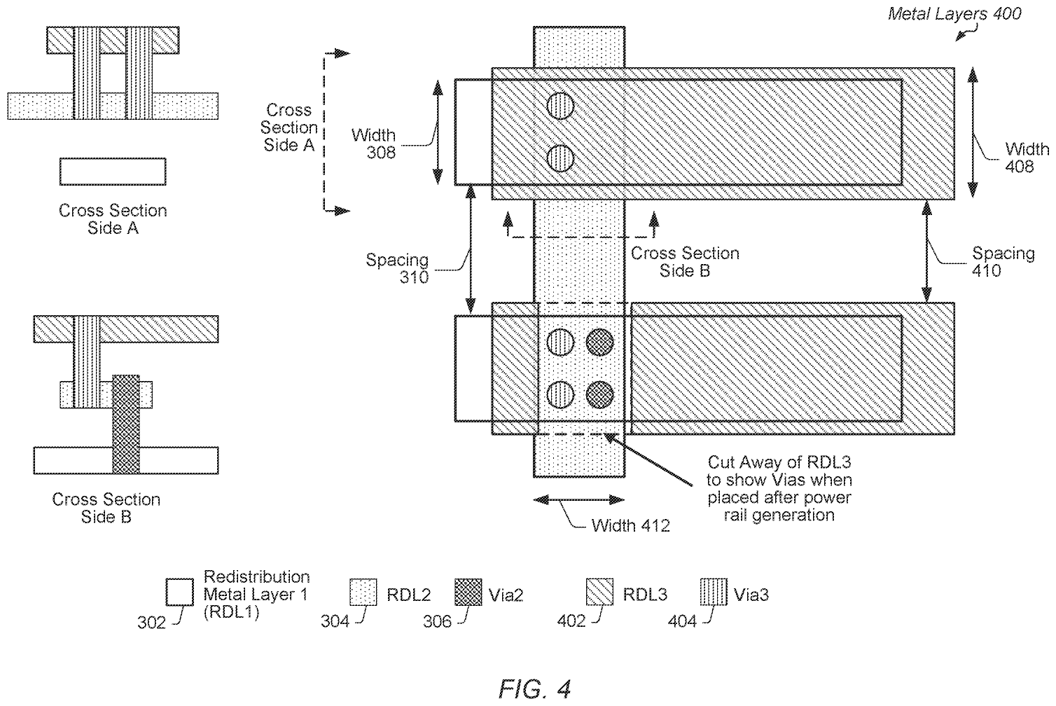

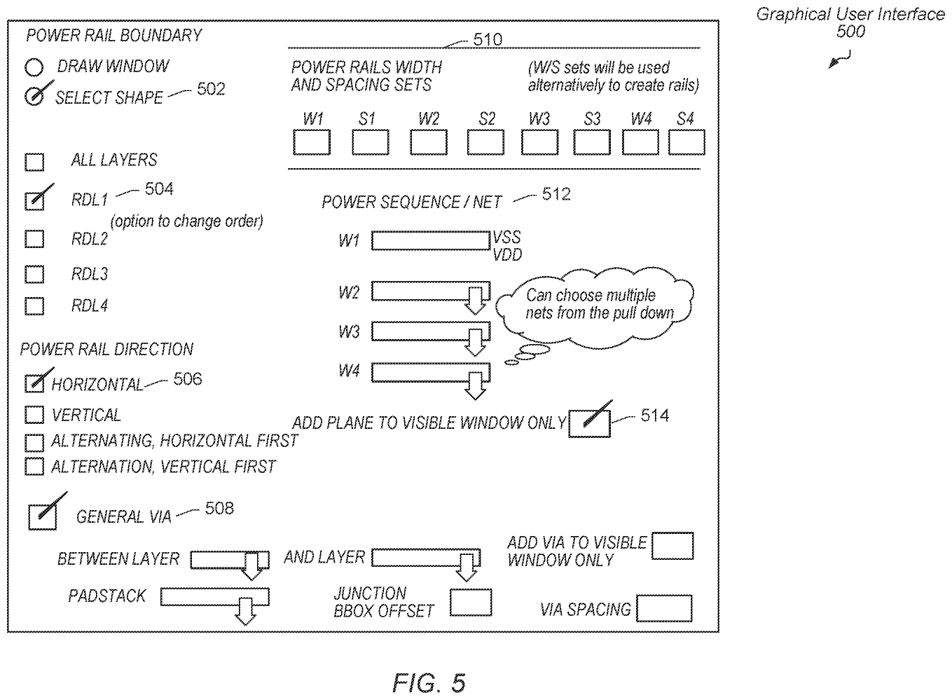

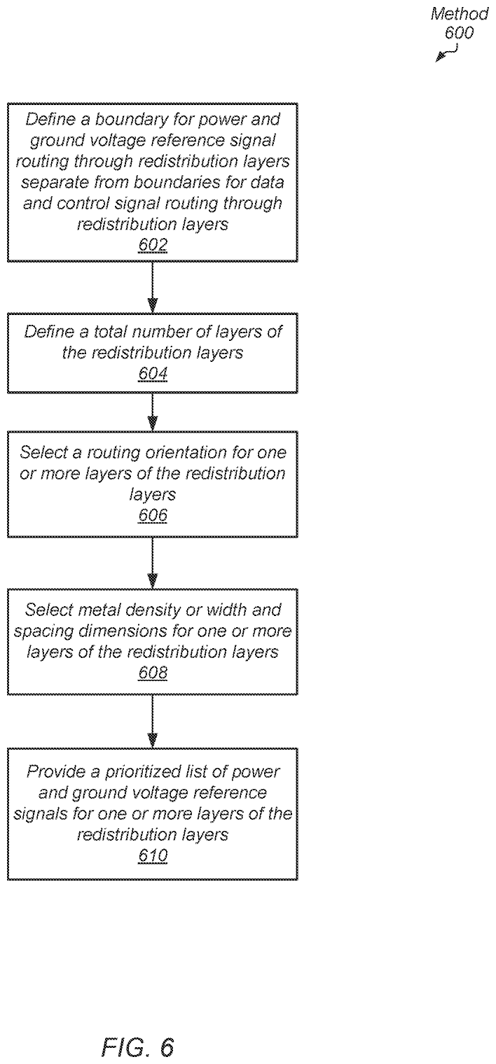

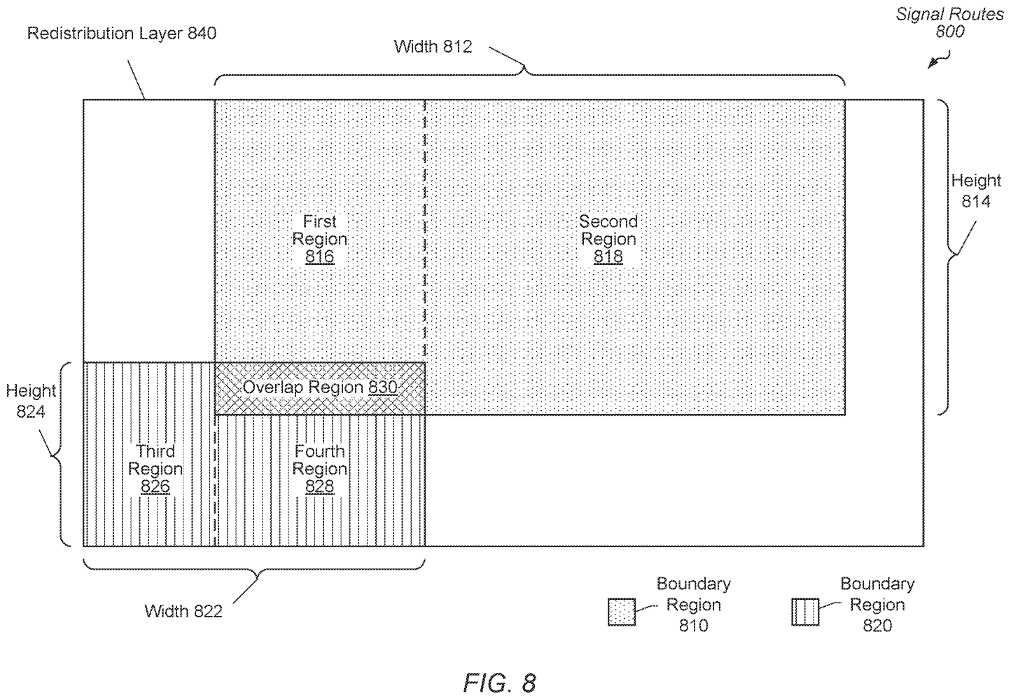

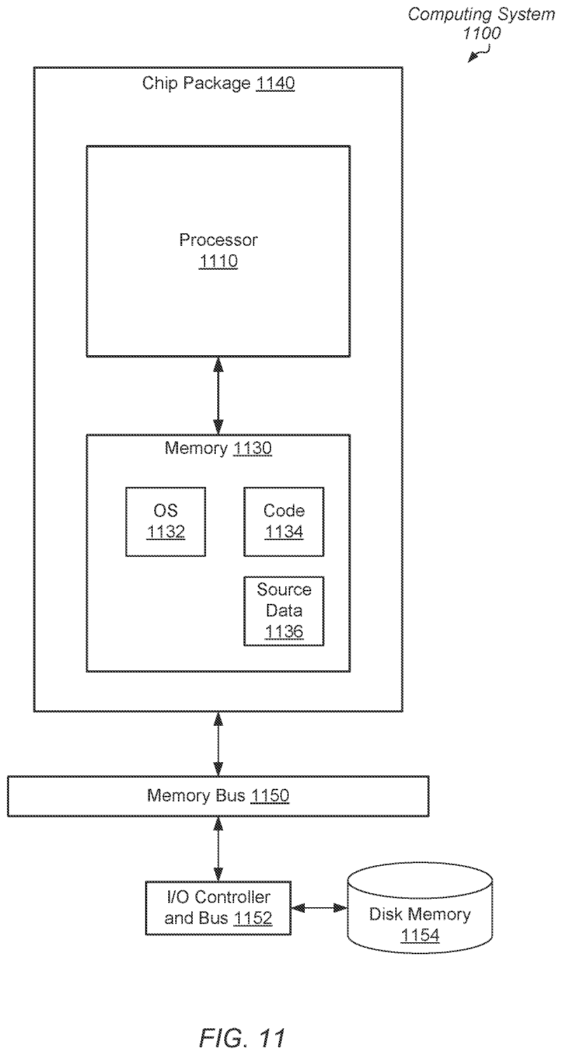

In the following description, a computing system is shown in FIG. 1 for supporting the development of a hardware product that uses a semiconductor package substrate. The computing system supports automatically creating layout masks for signal routes of power connections within redistribution layers. FIG. 2 illustrates the components of a semiconductor package, such as the redistribution layers, using flip chip technology. The FIGS. 3-4 illustrate the mask layout and overlap regions between adjacent metal layers of the redistribution layers. An example of a graphical user interface is shown in FIG. 5 for providing attributes from the user to utilize during the automatic generation of vias in the redistribution layers. FIGS. 6-7 and 9-10 provide methods to perform automatically determining signal routes of power connections within redistribution layers. In various embodiment, the methods are used for create layout masks. FIG. 8 illustrates signal routes at a particular redistribution level confined by boundary regions. An example of a fabricated chip package within a computing system is shown in FIG. 11. The fabricated chip package includes the automatically generated power rails in the redistribution layers.

Referring to FIG. 1, a generalized block diagram of one embodiment of a computing system 100 is shown. In the illustrated implementation, the computing system 100 includes the client computing device 150, the servers 120A-120D that include hardware for executing software and supporting the organizational center 110, a network 140, and the data storage 130 that includes one or more data stores supported and used by the organizational center 110. Although a single client computing device 150 is shown, any number of client computing devices utilize the organizational center 110 through the network 140. The client computing device 150, which is also referred to as client device 150, includes hardware, such as circuitry of a processor, to execute instructions of the automated redistribution layer (RDL) power rail generator 160. The automated RDL power rail generator 160 (or power rail generator 160) uses a copy of data stored in the data storage 130 and attributes 166 provided by a user. In an implementation, the user provides the attributes 166 through the graphical user interface (GUI) 162. Examples of data used by the power rail generator 160 are copies of the RDL netlist 134 and at least a portion of the design rule checks (DRCs) 136. The power rail generator 160 generates the RDL mask layout data 132 using the attributes 166 and the RDL netlist 134. A copy of the RDL mask layout data 132 is stored in one or more of the data storage 130 and the client device 150.

The client device 150 includes a desktop computer or a mobile computing device such as a laptop, a tablet computer, and so forth. The client device 150 includes hardware circuitry such as a processing unit 170 for processing instructions of computer programs. In some implementations, the processing unit 170 includes one or more homogeneous cores of a processor. In other embodiments, the processing unit includes heterogeneous cores such as a parallel processing architected core and a general-purpose core as used in central processing units (CPUs). The parallel architected core may be a graphics processing unit (GPU), a digital signal processing unit (DSP) or other.

The client device 150 includes a network interface (not shown) supporting one or more communication protocols for data and message transfers through the network 140. The network 140 includes multiple switches, routers, cables, wireless transmitters and the Internet for transferring messages and data. Accordingly, the network interfaces of the organizational center 110 and the client device 150 support at least the Hypertext Transfer Protocol (HTTP) for communication across the World Wide Web. In addition to communicating with the client device 150 through the network 140, the organizational center 110 also communicates with the data storage 130 for storing and retrieving data.

In various implementations, the organizational center 110 is an infrastructure for a vendor producing one or more hardware products. The organizational center 110 includes an intranet network providing a private network accessible only to an organization's staff. An intranet portal is used to provide access to resources with a user-friendly interface such as graphical user interfaces (GUIs) and dashboards. The information and services made available by the organizational center 110 is unavailable to the general public through direct access. Through user authentication, the staff members are able to access resources through the organizational center 110 to communicate with other staff members, collaborate on projects and monitor product development, update products, documents and tools stored in a centralized repository and so forth.

The servers 120A-120D used for supporting the organizational center 110 and resources accessed through the organizational center 110 include a variety of server types such as database servers, computing servers, application servers, file servers, mail servers and so on. In various implementations, the servers 120A-120D and the client device 150 operate with a client-server architectural model.

The client device 150 includes a copy of a particular version of a given software product or tool such as the power rail generator 160. In some implementations, the version of the power rail generator 160 is based on at least the operating system and the processor(s) used by the client device 150. The power rail generator 160 includes an engine 164 that when executed by the processor 170, causes the processor 170 to automatically generate layout masks for signal routes of power connections within redistribution layers of a semiconductor package. The power connections of the redistribution layers are signal routes located between an integrated circuit and a printed circuit board. For example, the signal routes of the redistribution layers are signal routes located between the micro-bumps that make contact with pads on the integrated circuit and through silicon vias (TSVs) of a silicon package substrate. The redistribution layers make it unnecessary to have a set of input/output (I/O) pads that are wire bonded to pins of the package, which eases chip-to-chip bonding.

As described earlier, the organizational center 110 is an infrastructure for a vendor producing one or more hardware products. The integrated circuit is one of a variety of types of integrated circuits being developed for production. With possibly tens of thousands of mask layers used to provide the signal routes in the redistribution layers, manually generating the mask layers for the power connections takes weeks or months. The power rail generator 160 performs this generation in a more efficient manner. Although the redistribution layers include control signal routes and data signal routes, in an implementation, the power rail generator 160 provides automatic generation of mask layers for power connections of the redistribution layers. The power connections provide one of a power supply voltage reference level or a ground reference voltage level used by the integrated circuit. To do so, the power rail generator 160 uses attributes 166 provided by a user.

In one implementation, the user provides the attributes 166 to the power rail generator 160 through the graphical user interface (GUI) 162. In another implementation, the user provides the attributes 166 to the power rail generator 160 through a text file or an executable file written in one of a variety of scripting languages. In an implementation, when the processor 170 executes the code of the engine 164 of the power rail generator 160, the processor 170 defines a routing orientation and metal density for each metal layer of the redistribution layers as specified by the attributes 166.

The processor 170, when executing the engine 164, also defines, as specified by the attributes 166, a boundary limiting (or confining) the area for power and ground voltage reference signal routing through redistribution layers. The processor 170, when executing the engine 164, further provides a prioritized list of power and ground voltage reference signals for each layer of the redistribution layers. The prioritized list determines a sequence order to follow for generating mask layout for the power and ground voltage reference signals for each layer of the redistribution layers.

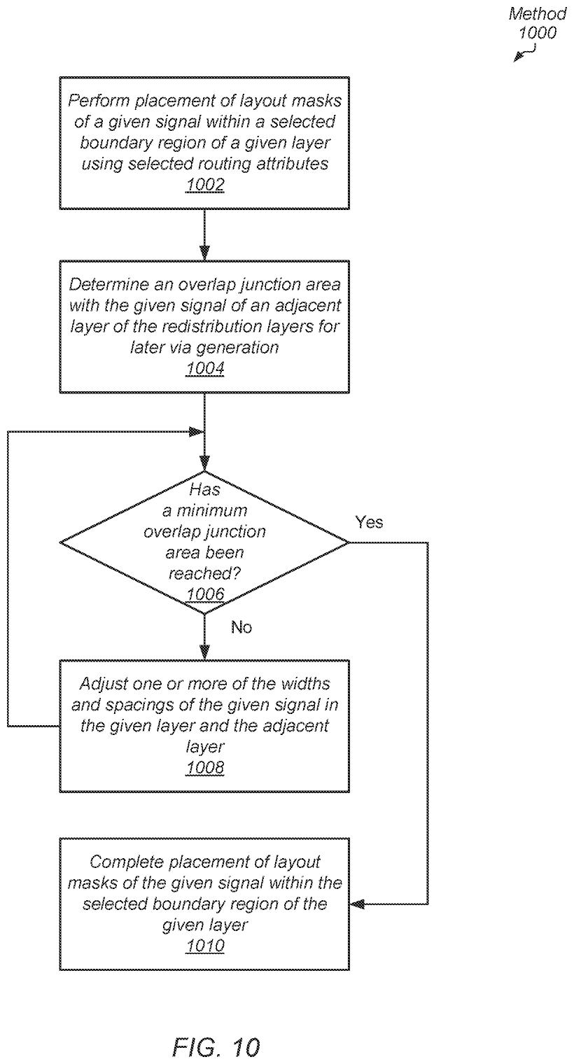

In some implementations, a given signal routed in a given layer of the redistribution layers has at least a first boundary region and a second boundary region defined for it. One of these two boundary regions has a higher priority than the other boundary region. The higher priority boundary region is routed first. In various implementations, the first boundary region and the second boundary region have different metal densities. When the processor 170 determines an overlap region exists between the first boundary region and the second boundary region, the processor 170 generates data indicative of a placement of the given signal using a first metal density of the first boundary region in the overlap region, a region adjacent to the overlap region in the first boundary region, and a region adjacent to the overlap region in the second boundary region. The processor 170 selected the first metal density due to determining that the first boundary region has a higher priority than the second boundary region. An illustrated description is provided later in FIG. 10.

The power rail generator 160 additionally uses copies of the RDL mask layout data 132 and the RDL netlist 134 to identify the placement of the metal layers in the redistribution layers. The power rail generator 160 also uses the DRCs 136 to verify that the placement of the vias does not violate design rules for layout. The power rail generator 160 takes into account design rule checks (e.g., spacing etc.). In some embodiments, another tool performs such checks (e.g., DRC and LVS checks). If the placement of vias pass the DRC and LVS checks, then one or more copies of an updated version of the RDL mask layout data 132 are stored at the client device 150 and the data storage 130. Following, a semiconductor chip tape out process is performed for the integrated circuit being developed, and a semiconductor fabrication process provides hardware of the integrated circuit to test.

Turning to FIG. 2, a generalized block diagram of a semiconductor package metal layer scheme 200 (or metal layer scheme 200) is shown that provides signal routes between an integrated circuit and a printed circuit board. As shown, the metal layer scheme 200 utilizes controlled collapse chip connection (C4) interconnections, which is also referred to as flip-chip interconnection. The two integrated circuits 210 and 212 have signal routes connected between them and the motherboard (or printed circuit board), which is not shown for ease of illustration. An interconnect may be connected to vertical through glass vias formed in a silicon package substrate that has connections to the printed circuit board using bump pads. The signal routes going to and from the integrated circuits 210 and 212 in addition to the signal routes between the motherboard via the interconnect 240 and the integrated circuits 210 and 212 are routed through the redistribution layers 230. In some implementations, the metal layer scheme 200 additionally includes a separate interposer (not shown) between the redistribution layers 230 and interconnect 240 (e.g., under-bump metallurgy). In an implementation, the interposer includes through silicon vias, whereas, the redistribution layers 230 do not include TSVs. In another implementation, each of the interposer and the redistribution layers 230 include one or more TSVs. In yet another implementation, no separate interposer is used as shown in FIG. 2.

Here, the integrated circuit is a system on a chip (SoC). As shown, one SOC is used in the hardware product. However, other examples of integrated circuits are possible and contemplated such as one or more of a CPU, a GPU, a multimedia engine, an application specific integrated circuit (ASIC), a digital signal processor (DSP), and so forth. The interconnect 240 provides a connection between the multiple redistribution layers (RDLs) 1 to 4 and the package substrate and motherboard. In some implementations, it is common to have a few hundred UBM layers and C4 bumps. Additionally, although four metal layers (RDLs 1-4) are used in redistribution layers 230, in other implementations a different number of metal layers is used. Between adjacent metal layers (RDLs 1-4) of the redistribution layers 230 are the vias of the layers labeled Via2 to Via4, which provide physical connection between adjacent layers of the redistribution layers 230. The redistribution layers 230 also include vias of the Via1 layer between the pins of the SMD pin layer and the metal layer RDL1. As shown, the redistribution layers 230 further include vias of the Via5 layer between the metal layer RDL4 and the interconnect 240.

The SoC 210 may have signals routed both to and from other SOCs (not shown) and the motherboard (printed circuit board) through at least the interconnect 240. The signals are routed through the metal layers of the redistribution layers 230 such as the metal layer designated as redistribution layer 1 (RDL1) and the metal layer designated as redistribution layer 4 (RDL4). These metal layers are also referred to as conductor 1 and conductor 4, respectively. In addition to the metal layers RDL1 to RDL4 of the redistribution layers 230, the signals are also routed through the pins of the surface mount device (SMD) Pin layer, and the via layers Via1 to Via5. Although the redistribution layers 230 include control signal routes and data signal routes, here, the signal routes shown distribute one or more of a power supply voltage reference level and a ground reference voltage level used by the SoC 210 and the SoC 212. Each of the SoC 210 and the SoC 212 is capable of using one or more power supply voltage reference levels and one or more ground reference voltage levels. In some cases, each of the SoC 210 and the SoC 212 has tens of thousands of nodes using pads 220 for receiving the power supply voltage reference levels and the one or more ground reference voltage levels while there are hundreds of UBMs for transferring these voltage reference levels. In some cases, each of the SoC 210 and the SoC 212 has tens of thousands of nodes using pads 220 for receiving the power supply voltage reference levels and the one or more ground reference voltage levels while there are hundreds of UBMs for transferring these voltage reference levels. The generation of the mask layout for these power connections of becomes complex. Manually generating the layout masks for the power connections takes weeks or months.

To make layout mask generation for the power connections more efficient, the circuitry of a processor executes instructions of a software tool that follows an algorithm developed by a software programmer that automatically creates layout masks for signal routes of power connections within redistribution layers based on attributes provided by a user. The tool, which is also referred to as a RDL automated power rail generator (or power rail generator), uses copies of the RDL netlist to identify the signal routes in the redistribution layers. The power rail generator also uses attributes supplied by a user. The power rail generator or another tool also performs DRC and LVS checks. After passing the checks, a semiconductor chip tape out process is performed for the integrated circuit being developed, and a semiconductor fabrication process provides hardware of the integrated circuit to test.

Referring to FIG. 3, a generalized block diagram of metal layers 300 is shown. As shown, two horizontal signal routes in the metal layer RDL 302 are connected by a vertical signal route in the metal layer RDL2 304. The cross sections of the side A and the side B are also provided to aid viewing the layout in three dimensions. The metal layers of RDL1 302 make a physical connection with the metal layer of RDL2 304 with the placement of the vias of the Via2 layer 306. Due to the width of the metal layer of RDL2 304, a single column of 2 vias of the Via2 layer 306 are placed. Therefore, each of the two metal layers RDL1 302 and the metal layer RDL2 304 are physically connected. In various implementations, these metal layers 302 and 304 provide a power supply voltage reference level or a ground reference voltage level used by a corresponding integrated circuit. The power rail generator automatically generates layout masks for the signal routes being shown prior to via generation and later fabrication. The power rail generator uses metal densities specified in attributes provided by the user. For example, the user selects the metal spacing 310 and the metal widths 308 and 312. The spacing for the metal layer of RDL2 304 is not shown for ease of illustration.

Although the orientations are described as horizontal and vertical, it is understood that the semiconductor package can be rotated and the redistribution layers would be rotated. The current orientations are used to describe the relationships between the metal layers and the vias. Here, the metal layer RDL2 304 is placed above the metal layer RDL1 302, so the SoC or other integrated circuit would be placed into the page in this diagram, whereas, the UBM and the silicon package substrate are located out of the page in this diagram. The reverse orientation is possible and contemplated, but for this discussion, the integrated circuit is located into the page.

Turning to FIG. 4, a generalized block diagram of metal layers 400 is shown. Materials and structures previously described are numbered identically. As shown, two horizontal signal routes in the metal layer RDL1 302 are connected by a vertical signal route in the metal layer RDL2 304. The cross sections of the side A and the side B are also provided to aid viewing the layout in three dimensions. Due to the larger width 412 of the metal layer of RDL2 304, two columns of 2 vias are placed. The metal layers of RDL1 302 make a physical connection with the metal layer of RDL2 304 with the placement of the vias of the Via2 layer 306. The metal density of the metal layer RDL3 402 uses the metal spacing 410 and the metal width 408 as specified by attributes provided by the user.

The cut away of the top metal layer RDL3 402 shows the placement of the single column of 2 vias of the Via2 layer 306. Additionally, two horizontal signal routes in the metal layer RDL3 402 are connected by the same vertical signal route in the metal layer RDL2 304. The metal layer RDL3 402 is located above the metal layer RDL2 304 using the previous orientation for metal layers 300 (of FIG. 3). Therefore, each of the two metal layers RDL1 302, the single metal layer RDL2 304, and the two metal layers RDL3 402 are physically connected when via generation is performed after the automatic power rail generation.

In various implementations, these metal layers 302, 304 and 402 provide a power supply voltage reference level or a ground reference voltage level used by a corresponding integrated circuit. The metal layers of RDL3 402 make a physical connection with the metal layer of RDL2 304 with the later placement of the vias of the Via3 layer 404. Due to the width of the metal layer of RDL2 304 and the area needed for the vias of the Via2 layer 306, a single column of 2 vias of the Via3 layer 404 are used by each of the metal layers of RDL3 402. It is noted that the vias of the Via2 layer 306 and the Via3 layer 404 have physical connections with only two adjacent layers, rather than three adjacent layers. In various implementations, the design rule checks (DRCs) do not allow for physical connections to a third metal layer. Therefore, as shown, the vias of the Via2 layer 306 are placed between the metal layers of RDL1 302 and RDL2 304, but the vias of the Via2 layer 306 do not continue in the vertical direction to make a physical connection with the metal layer of RDL3 402. Similarly, the vias of the Via3 layer 404 are placed between the metal layers of RDL2 304 and RDL3 402, but the vias of the Via3 layer 404 do not continue in the vertical direction to make a physical connection with the metal layer of RDL1 302. However, in other implementations, the DRCs permit the use of a through-hole via that is formed through three or more metal layers.

Turning to FIG. 5, a generalized block diagram of a graphical user interface (GUI) 500 is shown. As shown, the GUI 500 includes multiple selections for customizing multiple attributes used for automatic power rail generation in redistribution layers. The user is able to provide selections for the multiple attributes using one or more of a provided dropdown menu, an input box for receiving text, a checkbox or other shape that changes color to indicate a selection, and so forth. Box 502 allows the user to select a geographical area in the redistribution layers for automatic power rail generation. For example, the user is able to draw a shape with boundaries that define the area for automatic power rail generation. Alternatively, the user is able to select a preexisting shape that provides the boundaries.

Field 504 identifies which metal layers to customize. In some implementations, field 504 allows the user to define a sequence order for generating power rails on a metal layer basis. It is unnecessary to traverse the metal layers in a continuous adjacent manner. The user is able to customize the order of the metal layers that the auto power rail generator uses. Additionally, field 504 allows the user to define a number of metal layers to use for the automatic power rail generation. Field 506 indicates the orientation of one or more metal layers in the redistribution layers. In some cases, adjacent metal layers alternate between a horizontal orientation and a vertical orientation. In other cases, a pair of adjacent metal layers have a same orientation followed by another pair of adjacent metal layers using an opposite orientation.

Field 508 includes multiple sub-fields characterizing properties to be used when later via generation occurs. Although in some cases, via generation does not yet occur during the automatic power rail generation, the properties of the vias are used to provide layout masks of the power rails that satisfy DRC checks for the vias. The sub-fields include multiple categories of information such as the pad stack materials, types of vias and the corresponding metal layers, via spacing, and so forth. Field 510 includes multiple sub-fields that allow the user to specify the metal densities of the different metal layers, such as the multiple power rails, in the redistribution layers. The metal density of a given metal layer used as a power rail in the redistribution layers includes the metal spacing and the metal width of the given metal layer as specified by attributes provided by the user. As described earlier, in one example, the metal density of the metal layer RDL3 402 (of FIG. 4) includes the metal spacing 410 and the metal width 408 as specified by attributes provided by the user. The user is able to select one of a variety of metal width and metal spacing values for a particular power rail and its assigned metal layer.

In some cases, field 512 includes multiple sub-fields, such as multiple pulldown menus, that allow the user to specify power connection assignments and a sequence order. The integrated circuit uses one or more power supply voltage reference levels and one or more ground reference voltage levels. Therefore, the fields 504, 506, 510 and 512 allow the user to customize the sequence order for generating power rails on a metal layer basis, the assignment of which metal layer to use for a particular power rail voltage reference level, the orientation of the particular power rail, and the metal density (metal width and metal spacing) of the particular power rail. The fields 504, 506, 510 and 512 illustrate one implementation that allows a user to customize these characteristics that are used when generating the power rails within the redistribution layers. In other implementations, other types of fields of a GUI are used to customize these characteristics. In yet other implementations without a GUI, the user customizes these characteristics through a text file or an executable file written in one of a variety of scripting languages. Additionally, in some cases, the user is able to specify a particular area of the metal layer to limit the power rail generation for particular power and ground reference voltage levels. Further, the user is able to specify a priority of the power rail generation per metal layer based on the particular power and ground reference voltage level. Field 514 allows the user, during the automatic power rail generation, to generate power rails within the visible window such as a region visible on the computer screen.

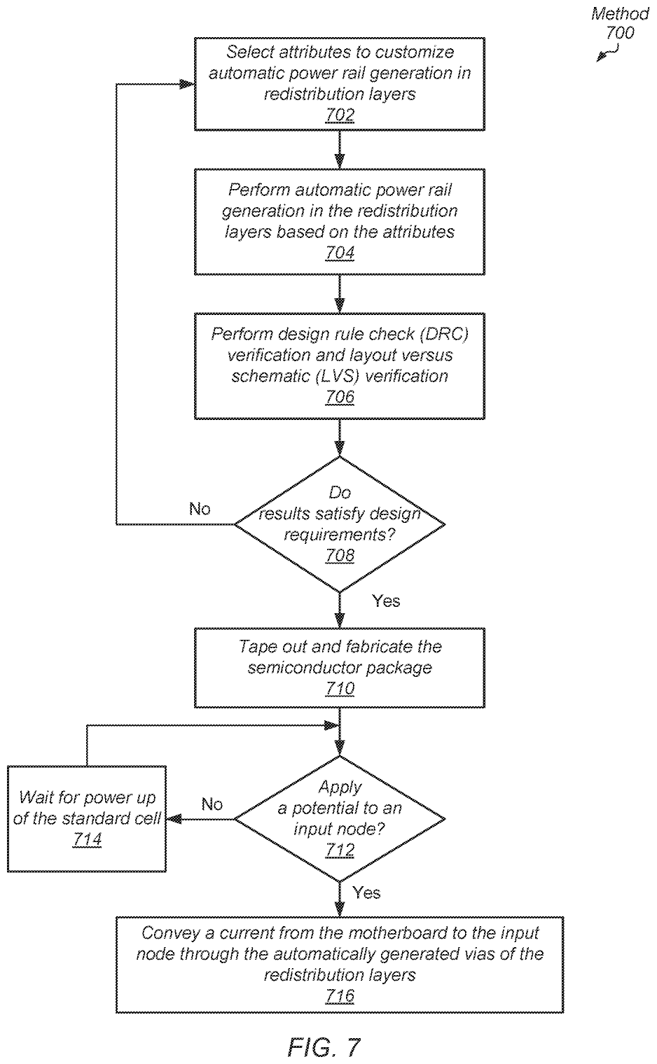

Referring now to FIG. 6, one embodiment of a method 600 for automatic power rail generation in redistribution layers is shown. For purposes of discussion, the steps in this embodiment (as well as for FIGS. 7 and 9-10) are shown in sequential order. However, in other embodiments, some steps occur in a different order than shown, some steps are performed concurrently, some steps are combined with other steps, and some steps are absent.

A user defines a boundary for power and ground voltage reference signal routing through redistribution layers (block 602). For example, the user selects attributes to customize automatic power rail generation in redistribution layers. In one implementation, the user provides the attributes to an auto via generator through the graphical user interface (GUI). The GUI 500 (of FIG. 5) is one example. In another implementation, the user provides the attributes to the power rail generator through a text file or an executable file written in one of a variety of scripting languages. The user specifies, in the attributes provided to the power rail generator, a total number of layers of the redistribution layers (block 604).

The user selects a routing orientation for one or more layers of the redistribution layers (block 606). The user selects a metal density, or width and spacing dimensions, for one or more layers of the redistribution layers (block 608). Additionally, in the attributes provided to the power rail generator, the user specifies a prioritized list of power and ground voltage reference signals for one or more layers of the redistribution layers (block 610).

Referring now to FIG. 7, one embodiment of a method 700 for automatic power rail generation in redistribution layers is shown. A user selects attributes to customize automatic power rail generation in redistribution layers (block 702). In one implementation, the user provides the attributes to a power rail generator through a graphical user interface (GUI). The GUI 500 (of FIG. 5) is one example. In another implementation, the user provides the attributes to the power rail generator through a text file or an executable file written in one of a variety of scripting languages. The user initiates execution of the power rail generator, and a processor of a corresponding computing device performs automatic power rail generation in the redistribution layers based on the attributes (block 704). The user executes one or more tools to perform design rule check (DRC) verification and layout versus schematic (LVS) verification (block 706).

The user determines whether the results of the automatic power rail generation satisfy design requirements. If the results do not satisfy design requirements (“no” branch of the conditional block 708), then control flow of method 700 returns to block 702 where the user selects different attributes. If the results satisfy design requirements (“yes” branch of the conditional block 708), then the design of the semiconductor package is taped out and fabricated (block 710).

If an electric potential is not applied to a first node of an integrated circuit in the semiconductor package (“no” branch of the conditional block 712), then the semiconductor package waits for power up (block 714). However, if a potential is applied to the first node created a potential difference (“yes” branch of the conditional block 710), then metal layers and vias that were automatically generated in the redistribution layers conveys a current between the integrated circuit and the motherboard (block 716).

Referring to FIG. 8, a generalized block diagram of signal routes 800 is shown. In various implementations, the signal routes 800 include signal routes of a particular one of the multiple power supply and ground voltage reference signals, a particular redistribution layer 840 of the multiple redistribution layers, and a particular orientation. In an implementation, the redistribution layer 840 is RDL1. Additionally, in this implementation, the signal routes 800 include a given power supply voltage reference signal with multiple signal routes in a vertical orientation with placement of the metal layers of these signal routes being bounded within boundary region 810 that has width 812 and height 814. The boundary region 810 includes the first region 816 and second region 818. Further, in this implementation, the placement of these signal routes is bounded within boundary region 820 that has width 822 and height 824. The boundary region 820 includes the third region 826 and fourth region 828. In this implementation, the metal density of the signal routes within the boundary region 810 is different than the metal density of the signal routes within the boundary region 820.

As described earlier, the user selects attributes to customize automatic power rail generation in the redistribution layers using one of a GUI, a text file, or an executable file. For the given power supply voltage reference routed in the vertical direction in RDL 1 (redistribution layer 840), the user selects the dimensions of the width 812 and the height 814 of boundary region 810, and selects the dimensions of the width 822 and the height 824 of boundary region 820. Additionally, the user selects sets of metal widths and spacings to use for signal routes within boundary region 810 and the boundary region 820. As shown, the boundary regions 810 and 820 overlap one another within the overlap region 830. In some implementations, the overlap region 830 is an abutment between the first region 816 and the fourth region 828, rather than a positive, non-zero amount of overlap between the regions 816 and 828.

When the power rail generator (or generator) determines the overlap region 830 exists and the sets of metal widths and spacings of the given power supply voltage reference in boundary regions 810 and 820 are different, the generator selects one of the sets of metal widths and spacings (or sets) of the boundary regions 810 and 820 to use in the overlap region 830. The generator also uses the selected set in the first region 816 above the overlap region 830, which is also located within the boundary region 810. The generator also uses the selected set in the fourth region 828 below the overlap region 830, which is also located within the boundary region 820. In various implementations, the generator selects the set based on priorities of the boundary regions 810 and 820. For example, the attributes include the priorities.

The generator places signal routes within the first region 816, the overlap region 830, and the fourth region 828 using the selected set. Therefore, the vertical signal routes are routed from the top of the first region 816 to the bottom of the fourth region 828 using the selected set of metal widths and spacings. Outside of the first region 816, the overlap region 830, and the fourth region 828, but within the boundary regions 810 and 820, the generator uses the respective set of metal width and spacing assigned to the boundary region 810 and the boundary region 820. For example, within the second region 818, the generator uses the set of metal width and spacing assigned to the boundary region 810. In a similar manner, within the third region 826, the generator uses the set of metal width and spacing assigned to the boundary region 820.

As described earlier, the metal routes are placed for one of the boundary regions 810 and 820 prior to the metal routes are placed for the other one of the boundary regions 810 and 820. Therefore, the generator merely extends the pre-existing metal routes in the overlap region 830 into the other one of the boundary regions 810 and 820. For example, if the boundary region 810 has higher priority than the boundary region 820, then the selected set of metal width and spacing is the set assigned to boundary region 810. Additionally, the generator merely extends the pre-existing metal routes in the first region 816 and the overlap region 130 into the fourth region 828. The generator places the metal routes in the third region 826, though, using the set of metal width and spacing assigned to the boundary 820. Although the above examples use vertical metal routes, one of the power supply references, and the redistribution layer RDL1, in other implementations, a variety of different combinations of these parameters are possible and contemplated.

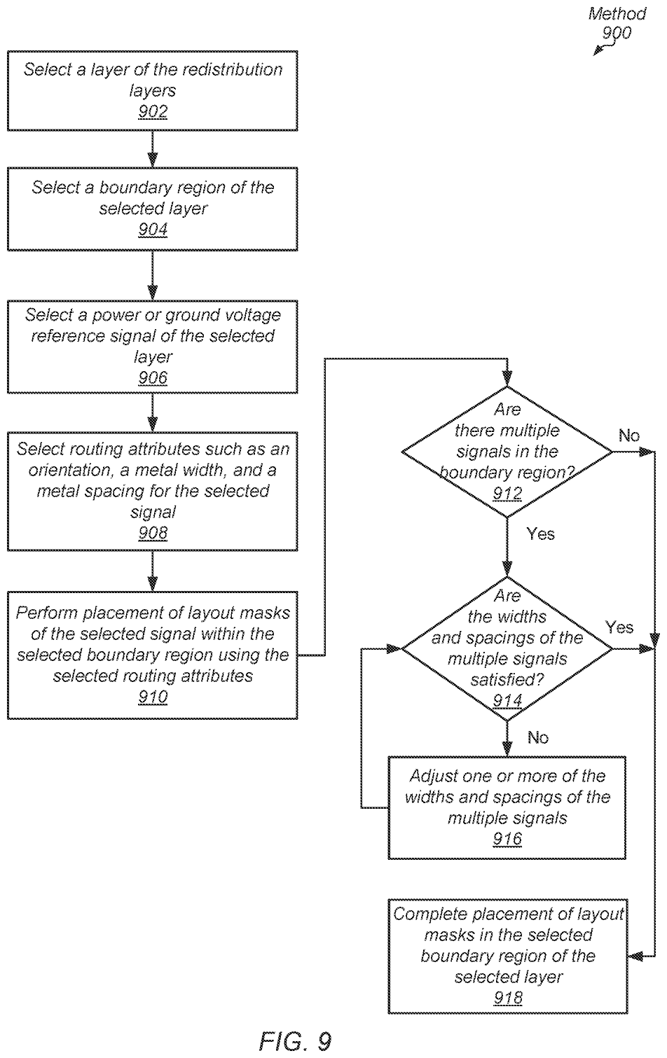

Turning now to FIG. 9, one embodiment of a method 900 for automatic power rail generation in redistribution layers is shown. As described earlier, a user provides the attributes to a power rail generator through a GUI, a text file, or an executable file written in one of a variety of scripting languages. The hardware of a processor of a corresponding computing device executes the power rail generator to perform automatic power rail generation in the redistribution layers based on the attributes. For example, the power rail generator (based on execution of the hardware of the processor) selects a layer of the redistribution layers (block 902). The power rail generator selects a boundary region of the selected layer (block 904). The power rail generator selects a power or ground voltage reference signal of the selected layer (block 906). The power rail generator selects routing attributes such as an orientation, a metal width, and a metal spacing for the selected signal (block 908). Each of these selections is based on the attributes.

The power rail generator performs placement of layout masks of the selected signal within the selected boundary region using the selected routing attributes (block 910). If the power rail generator determines that there are multiple signals in the boundary region (“yes” branch of the conditional block 912), and the power rail generator determines that the widths and spacings of the multiple signals are not satisfied (“no” branch of the conditional block 914), then the power rail generator adjusts one or more of the widths and spacings of the multiple signals (block 916). In some implementations, the power rail generator determines the metal widths and spacings are satisfied based on the metal widths and spacings specified in the user attributes. As such, the adjustment(s) to the one or more of the widths and spacings of the multiple signals such are performed such that they fall within a density rule window (i.e., a range of densities). In some implementations, the power rail generator determines the metal widths and spacings are satisfied based on a file provided by a fabrication manufacturer that provides supported metal widths and spacings of signals at particular layers of the redistribution layers. For example, should the power rail generator adjust the metal widths and spacings of a given signal from values specified in the user attributes, the new values should be found in this file from the fabrication manufacturer.

In some implementations, the power rail generator maintains the metal densities specified in the attributes. For example, the power rail generator selects a set of metal width and spacing with each of the width and spacing being one half of an original set of metal width and spacing specified in the attributes. However, the ratio of width to spacing remains the same. In an implementation, to select adjusted metal widths and spacings, the power rail generator accesses a file provided by a fabrication manufacturer that provides supported metal widths and spacings of signals at particular layers of the redistribution layers. In an implementation, when the power rail generator has exhausted all of the supported widths and spacings for a given metal density (or ratio of width to spacing), the power rail generator begins selecting supported metal widths and spacings that provide different metal densities.

In various implementations, the power rail generator updates a log file with its choices and results for a user to inspect at a later time. In some implementations, the power rail generator selects a signal to adjust based on being the lowest priority of the multiple signals. The power rail generator continues to move up the prioritized list of signals from lowest to highest until each of the multiple signals have widths and spacings that are found in the file of supported widths and spacings from the fabrication manufacturer.

After adjusting metal widths and spacings of at least one signal of the multiple signals, control flow of method 900 returns to conditional block 914 where the power rail generator determines whether the widths and spacings of the multiple signals are satisfied. If the power rail generator determines that there are not multiple signals in the boundary region (“no” branch of the conditional block 912), or the power rail generator determines that the widths and spacings of the multiple signals are satisfied (“yes” branch of the conditional block 914), then the power rail generator completes placement of layout masks in the selected boundary region of the selected layer (block 918).

Referring to FIG. 10, one embodiment of a method 1000 for automatic power rail generation in redistribution layers is shown. The hardware of a processor of a corresponding computing device executes the power rail generator to perform automatic power rail generation in the redistribution layers based on user attributes. For example, the power rail generator performs placement of layout masks of a given signal within a selected boundary region of a given layer using selected routing attributes (block 1002). The multiple steps used to perform the placement are described further in the above description of method 900 (of FIG. 9). However, before checking whether multiple signals are within the selected boundary region, in an implementation, the power rail generator first checks whether the current placement is valid with regard to the same selected signal on an adjacent layer of the redistribution layers. For example, the power rail generator determines an overlap junction area with the given signal of an adjacent layer of the redistribution layers for later via generation (block 1004). For example, the power rail generator compares the overlap junction area, which is the overlap region between two adjacent metal layers, to a minimum overlap junction area threshold.

If the minimum overlap junction area is not reached for later via generation (“no” branch of the conditional block 1006), then the power rail generator being executed by the processor adjusts one or more of the widths and spacings of the given signal in the given layer and the adjacent layer (block 1008). In some implementations, the power rail generator selects which layer to begin adjusting based on priorities of the given layer and the adjacent layer specified in the user attributes. The updating of the metal widths and spacings follows similar steps as described earlier regarding block 916 of method 900 (of FIG. 9).

In some implementations, the power rail generator selects the adjacent layer based on the priorities specified in the user attributes. For example, when the given layer is RDL3, the selected adjacent layer is either RDL4 or RDL2. If the user selected a downward direction for performing power rail generation, then the overlap junction area checks are already done between RDL4 and RDL3, so the current selected adjacent layer is RDL2. Other choices and directions are possible and contemplated. If the minimum overlap junction area is reached for later via generation (“yes” branch of the conditional block 1006), then the power rail generator being executed by the processor complete placement of layout masks of the given signal within the selected boundary region of the given layer (block 1010). The power rail generator is able to move on to a next signal or a next layer for power rail generation.

Referring to FIG. 11, one implementation of a computing system 1100 is shown that utilizes redistribution layers with automatically generated power rails. The computing system 1100 utilizes a chip package 1140, which includes the automatically generated power rails in the redistribution layers. The chip package 1140 uses one of a ball grid array (BGA) surface mount package, a chip scale package (CSP), and a System in Package (SiP) that communicates with other components on a motherboard (or printed circuit board). In an implementation, the computing system 1100 includes the processor 1110 and the memory 1130 in the chip package 1140. In another implementation, only one of the includes the processor 1110 and the memory 1130 in the chip package 1140 is included in the chip package 1140. Interfaces, such as a memory controller, a bus or a communication fabric, one or more phased locked loops (PLLs) and other clock generation circuitry, a power management unit, and so forth, are not shown for ease of illustration. Additionally, in the illustrated implementation, the chip package 1140 is connected to the disk memory 1154 through the memory bus 1150 and the input/output (I/O) controller and bus 1152.

It is understood that in other implementations, the computing system 1100 includes one or more of other processors of a same type or a different type than processor 1110, one or more peripheral devices, a network interface, one or more other memory devices, and so forth. In some implementations, the functionality of the computing system 1100 is incorporated on a system on chip (SoC). In other implementations, the functionality of the computing system 1100 is incorporated on a peripheral card inserted in a motherboard. The computing system 1100 is used in any of a variety of computing devices such as a desktop computer, a tablet computer, a laptop, a smartphone, a smartwatch, a gaming console, a personal assistant device, and so forth.

The processor 1110 includes hardware such as circuitry. In various implementations, the processor 1110 includes one or more processing units. In some implementations, each of the processing units includes one or more processor cores capable of general-purpose data processing, and an associated cache memory subsystem. In such an implementation, the processor 1110 is a central processing unit (CPU). In another implementation, the processing cores are compute units, each with a highly parallel data microarchitecture with multiple parallel execution lanes and an associated data storage buffer. In such an implementation, the processor 1110 is a graphics processing unit (GPU), a digital signal processor (DSP), or other.

In some implementations, the memory 1130 includes one of a variety of types of dynamic random access memories (DRAMs). The memory 1130 stores at least a portion of an operating system (OS) 1132, one or more applications represented by code 1134, and at least source data 1136. In various implementations, the memory 1130 stores a copy of these software components 1132, 1134 and 1136 that have original copies stored on disk memory 1154. Memory 1130 is also capable of storing intermediate result data and final result data generated by the processor 1110 when executing a particular application of code 1134.

In various implementations, the off-chip disk memory 1154 includes one or more hard disk drives (HDDs) and Solid-State Disks (SSDs) comprising banks of Flash memory. The I/O controller and bus 1152 supports communication protocols with the off-chip disk memory 1154. Although a single operating system 1132 and a single instance of code 1134 and source data 1136 are shown, in other implementations, another number of these software components are stored in memory 1130 and disk memory 1154. The operating system 1132 includes instructions for initiating the boot up of the processor 1110, assigning tasks to hardware circuitry, managing resources of the computing system 1100 and hosting one or more virtual environments.

It is noted that one or more of the above-described embodiments include software. In such embodiments, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g. synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g. Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various embodiments, program instructions include behavioral-level descriptions or register-transfer level (RTL) descriptions of the hardware functionality in a high level programming language such as C, or a design language (HDL) such as Verilog, VHDL, or database format such as GDS II stream format (GDSII). In some cases the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware based type emulator from such vendors as Cadence®, EVE®, and Mentor Graphics®.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A processor comprising:
circuitry configured to:
receive a plurality of attributes corresponding to placement of one or more signal types in a plurality of levels of metal layers; and
generate data indicative of a placement of the one or more signal types in the plurality of levels of metal layers, based at least in part on the attributes comprising at least an identification of one or more boundary regions, each identifying confined placement of a given signal in a given level of the plurality of levels of metal layers.

2. The processor as recited in claim 1, wherein the circuitry is further configured to generate data indicative of a confined placement of a given signal type in a given level of the plurality of levels of metal layers within:
a first boundary region of the one or more boundary regions in the given level using a first metal density; and
a second boundary region of the one or more boundary regions in the given level using a second metal density.

3. The processor as recited in claim 2, wherein in response to determining an overlap region exists between the first boundary region and the second boundary region, the circuitry is further configured to generate data indicative of a placement of the given signal type using the first metal density in the overlap region, a region adjacent to the overlap region in the first boundary region, and a region adjacent to the overlap region in the second boundary region.

4. The processor as recited in claim 3, wherein the circuitry is further configured to determine the first boundary region has higher priority than the second boundary region.

5. The processor as recited in claim 1, wherein the circuitry is further configured to generate a report that indicates whether the placement of the one or more signal types in the plurality of levels of metal layers includes a minimum junction area specified by the plurality of attributes.

6. The processor as recited in claim 1, wherein the circuitry is further configured to generate the placement of the one or more signal types of the plurality of levels of metal layers in an order of sequences specified by the plurality of attributes, wherein each sequence identifies one of the plurality of levels of metal layers.

7. The processor as recited in claim 1, wherein the plurality of levels of metal layers are redistribution layers between an integrated circuit and a printed circuit board.

8. A method comprising:
receiving, by circuitry of a processor, a plurality of attributes corresponding to placement of one or more signal types in a plurality of levels of metal layers; and
generating, by the circuitry, data indicative of a placement of the one or more signal types in the plurality of levels of metal layers, based at least in part on the attributes comprising at least an identification of one or more boundary regions, each identifying confined placement of a given signal in a given level of the plurality of levels of metal layers.

9. The method as recited in claim 8, further comprising generating, by the circuitry, data indicative of a confined placement of a given signal type in a given level of the plurality of levels of metal layers within:
a first boundary region of the one or more boundary regions in the given level using a first metal density; and
a second boundary region of the one or more boundary regions in the given level using a second metal density.

10. The method as recited in claim 9, wherein in response to determining an overlap region exists between the first boundary region and the second boundary region, the method further comprises generating, by the circuitry, data indicative of a placement of the given signal type using the first metal density in the overlap region, a region adjacent to the overlap region in the first boundary region, and a region adjacent to the overlap region in the second boundary region.

11. The method as recited in claim 10, further comprising determining, by the circuitry, the first boundary region has higher priority than the second boundary region.

12. The method as recited in claim 8, further comprising generating, by the circuitry, a report that indicates whether the placement of the one or more signal types in the plurality of levels of metal layers includes a minimum junction area specified by the plurality of attributes.

13. The method as recited in claim 8, further comprising generating, by the circuitry, the placement of the one or more signal types of the plurality of levels of metal layers in an order of sequences specified by the plurality of attributes, wherein each sequence identifies one of the plurality of levels of metal layers.

14. The method as recited in claim 8, wherein the plurality of levels of metal layers are redistribution layers between an integrated circuit and a printed circuit board.

15. A computing system comprising:
a processing unit;
a memory coupled to the processing unit, wherein the memory is configured to store a netlist;
wherein circuitry of the processing unit is configured to:
receive a plurality of attributes corresponding to placement of one or more signal types in a plurality of levels of metal layers;
receive the netlist; and
generate data indicative of a placement of the one or more signal types in the plurality of levels of metal layers, based at least in part on:
the netlist; and
the attributes comprising at least an identification of one or more boundary regions, each identifying confined placement of a given signal in a given level of the plurality of levels of metal layers.

16. The computing system as recited in claim 15, wherein the circuitry is further configured to generate data indicative of a confined placement of a given signal type in a given level of the plurality of levels of metal layers within:
a first boundary region of the one or more boundary regions in the given level using a first metal density; and
a second boundary region of the one or more boundary regions in the given level using a second metal density.

17. The computing system as recited in claim 16, wherein in response to determining an overlap region exists between the first boundary region and the second boundary region, the circuitry is further configured to generate data indicative of a placement of the given signal type using the first metal density in the overlap region, a region adjacent to the overlap region in the first boundary region, and a region adjacent to the overlap region in the second boundary region.

18. The computing system as recited in claim 17, wherein the circuitry is further configured to determine the first boundary region has higher priority than the second boundary region.

19. The computing system as recited in claim 15, wherein the circuitry is further configured to generate a report that indicates whether the placement of the one or more signal types in the plurality of levels of metal layers includes a minimum junction area specified by the plurality of attributes.

20. The computing system as recited in claim 19, wherein the plurality of levels of metal layers are redistribution layers between an integrated circuit and a printed circuit board.
